(19) United States
(12) Patent Application Publication
(10) Pub. No.: US 2022/0067867 A1
(43) Pub. Date: Mar. 3, 2022

(54) SYSTEM AND METHOD FOR MONITORING A LOADING DOCK

(71) Applicant: DMI, LLC, Dubuque, IA (US)

(72) Inventors: NATHAN LEE GREINER, HANOVER, IL (US); BRIAN ALAN VESPERMAN, MADISON, WI (US)

(21) Appl. No.: 17/007,865

(22) Filed: Aug. 31, 2020

(51) Int. Cl. G06Q 50/28; G01C 9/00; G06Q 10/06; G06Q 10/00

(52) U.S. Cl. CPC G06Q 50/28; G01C 9/00; G07C 9/00; G06Q 10/20; G06Q 10/06312

(57) ABSTRACT

A dock monitoring system includes one or more sensors for monitoring equipment or areas within the dock. The sensors can include a presence sensor, a dock door sensor, and/or a dock leveler sensor. The sensors can communicate with a controller to process sensor data. The controller can determine various information using the sensor data. Such information can be transmitted to a server for storage in a database, or to generate notifications and/or alerts related to the dock or dock equipment. A user may use a user device such as a computer or a mobile device to view the information, notifications, and alerts.

### TECHNICAL FIELD

The present invention relates to a system that includes sensors for monitoring aspects of a loading dock.

### BACKGROUND

Docks at locations such as warehouses, storage facilities, and manufacturing facilities serve an important role in the logistical cycle of shipping and delivering goods. Delays in the loading or unloading of trucks could cause bottlenecks in the transportation process. Repetitive usage of various equipment utilized in the dock can cause wear and tear on the components, which creates an increased risk of equipment failures and downtime. Routine monitoring of dock usage and inspection of dock equipment mitigates such risks.

### SUMMARY

This summary is provided herein to help enable a general understanding of various aspects of exemplary, non-limiting embodiments that follow in the more detailed descriptions and the accompanying drawings. This summary is not intended, however, as an extensive or exhaustive overview. Instead, the sole purpose of the summary is to present some concepts related to some exemplary non-limiting embodiments in a simplified form as a prelude to the more detailed description of the various embodiments that follow.

In various, non-limiting embodiments, a dock monitoring system is provided. A sensor system includes a presence sensor. The presence sensor includes a transmitter configured to transmit a sensing signal, and a receiver configured to receive a return signal reflected off of an object in a predefined area. Based on a receipt of the return signal, the presence sensor is configured to transmit a presence signal. The sensor system further includes a controller configured to receive the presence signal from the presence sensor.

In certain embodiments, the presence sensor is positioned in a loading dock, wherein the object is a truck and the predefined area is within the loading dock.

In certain embodiments, the controller is further configured to calculate a distance of the object from the presence sensor based on the presence signal.

In certain embodiments, the controller is further configured to detect a change in the distance of the object from the presence sensor based on the presence signal.

In certain embodiments, the controller is configured to determine an arrival time of the object based on the presence signal.

In certain embodiments, the controller is configured to determine a departure time of the object based on the presence signal.

In certain embodiments, the sensor system further includes a server configured to receive, from the controller, the departure time of the object; determine that the departure time is later than a scheduled departure time; and, based on determining that the departure time is later than the scheduled departure time, provide a notification to a user device.

In certain embodiments, the presence sensor further includes an aperture. The transmitter is configured to transmit the sensing signal through the aperture and the receiver is configured to receive the return signal through the aperture.

In certain embodiments, the sensor system further includes a door sensor including an actuator and a door receiver unit configured to detect a proximity of the actuator and transmit a door position signal based on detection of the proximity of the actuator. The sensor system can further include a dock leveler sensor including at least one sensing element configured to detect at least one of a position of a dock leveler, or a weight applied to the dock leveler. The dock leveler sensor is configured to transmit a dock leveler sensor signal including at least one of the position or the weight. The controller is further configured to receive the door position signal from the door sensor, and the dock leveler signal from the dock leveler sensor.

In certain embodiments, the controller is further configured to determine usage data pertaining to a door based on the door position signal.

In certain embodiments, the sensor system includes a server configured to receive the usage data from the controller; compare the usage data to a maintenance schedule; and based on the comparison of the usage data to the maintenance schedule, provide a notification to a user device that maintenance is required on the door.

In certain embodiments, the controller is further configured to calculate an amount of time that a door corresponding to the door sensor has been opened.

In certain embodiments, the controller is further configured to determine at least one of weight data or operation data pertaining to a dock leveler based on the dock leveler signal.

In certain embodiments, the controller is further configured to determine load count data pertaining to a dock leveler based on the dock leveler signal.

In certain embodiments, the server is configured to receive the load count data from the controller; compare the load count data to a maintenance schedule; and based on the comparison of the load count data to a maintenance schedule, provide a notification to a user device that maintenance is required on the dock leveler.

In various, non-limiting embodiments, a method of monitoring activity within a dock is provided. The method includes receiving a presence signal from a presence sensor; determining, based on the presence signal, a presence of a truck within a predefined area in the dock; and calculating a first distance of the truck from the presence sensor based on the presence signal.

In certain embodiments, the method further includes calculating a second distance of the truck from the presence sensor based on the presence signal; determining that the second distance is different from the first distance; and based on determining that the second distance is different from the first distance, determining that the truck is either arriving or departing.

In certain embodiments, the method further includes receiving a dock door signal from a door sensor; and receiving a dock leveler signal from a dock leveler sensor.

In certain embodiments, the method further includes determining that maintenance is required on at least one of the dock door or the dock leveler based on at least one of the dock door signal or the dock leveler signal.

In various, non-limiting embodiments, a dock monitoring system is provided. A sensor system includes a presence sensor positioned within a dock, a dock door sensor positioned proximate to a dock door, a dock leveler sensor positioned proximate to a dock leveler, a controller configured to communicate with the presence sensor, the dock door sensor, and the dock leveler sensor, and a server configured to receive, from the controller, and store data based on information provided by the presence sensor, the dock door sensor, and the dock leveler sensor. The server is further configured to provide at least one of maintenance information or operational information related to a presence of trucks in the dock, operation of the dock door, and operation of the dock leveler.

These and other features of this invention will be evident when viewed in light of the drawings, detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 is a schematic representation of an exemplary dock sensor system;

FIG. 2A is a schematic representation of an exemplary presence sensor;

FIG. 2B is an overhead view of an exemplary presence sensor in a dock environment;

FIG. 3A is a schematic representation of an exemplary door sensor;

FIG. 3B is a front view of a door equipped with an exemplary door sensor;

FIG. 4A is a schematic representation of an exemplary dock leveler sensor;

FIG. 4B is a side view of a dock leveler equipped with an exemplary dock leveler sensor;

FIG. 5 is a flow diagram depicting a method of monitoring activity within a dock; and

FIG. 6 is a flow diagram depicting a method of monitoring activity within a dock.

### DETAILED DESCRIPTION

Docks provide a hub for loading and unloading goods that are in a transportation or commerce stream. Docks include various equipment that interact in a way to provide access, for example, to trucks and other machinery used for loading or unloading the trucks. Efficient and reliable utilization of the dock equipment can streamline the transportation process and eliminate bottlenecks in the logistical stream. In accordance with various embodiments described herein, a dock monitoring system includes one or more sensors for monitoring equipment and/or areas within the dock. The sensors can include a presence sensor, a dock door sensor, and/or a dock leveler sensor. The sensors can communicate with a controller to process sensor data. The controller can determine various information using the sensor data. Such information can be transmitted to a server for storage in a database. Further, based on the information, the controller and/or server can generate notifications or alerts related to the dock or dock equipment. A user may use a user device such as a computer, a mobile device, or other computing device to view the information, notifications, and alerts. Additional advantages of the embodiments provided herein will be apparent to one of ordinary skill in the art.

With reference to the drawings, like reference numerals designate identical or corresponding parts throughout the several views. The inclusion of like elements in different views does not mean a given embodiment necessarily includes such elements or that all embodiments of the invention include such elements. The examples and figures are illustrative only and not meant to limit the invention, which is measured by the scope and spirit of the claims. Moreover, it should be understood that the drawings may not depict features to scale. The drawings may enlarge or exaggerate certain features to facilitate visualization.

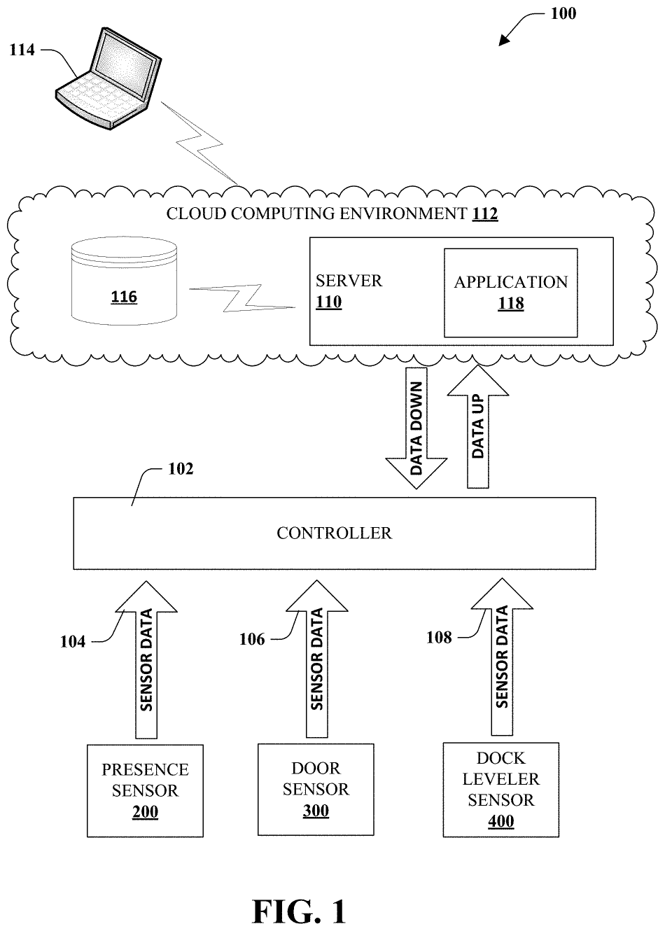

FIG. 1 depicts an exemplary dock monitoring system 100. The dock monitoring system 100 can include a controller 102 configured to communicate with a presence sensor 200, a dock door sensor 300, and/or a dock leveler sensor 400. The controller 102, which can also be referred to as a gateway, can receive data from various sensors via a wired or wireless communication link. For example, the controller 102 can receive a presence signal 104 from the presence sensor 200, a door signal 106 from the door sensor 300, and a dock leveler signal 108 from the dock leveler sensor 400. Each of the presence signal 104, the door signal 106, and the dock leveler signal 108 can include information as described below in greater detail. The controller 102 can be located locally to the various sensors, or remotely. The controller 102 can receive the various sensor signals, store the corresponding information, and/or perform various processing or calculations with the information.

In certain embodiments, the controller 102 can also communicate the sensor information in a raw or a processed form to a server 110. It should be appreciated that the server 110 can be local, remote, or cloud-based as part of a cloud computing environment 112. In various embodiments, the controller 102 can exist as part of the server 110. The server 110 can also be distributed among multiple locations and/or devices. It is to be appreciated that the server 110 can be at least one of a website, a server device, a computer, a cloud-service, a processor and memory, or a computing device connected to the Internet and connected to a user device 114. In general, a network can be implemented to couple one or more devices of system 100 via wired or wireless connectivity, over which data communications are enabled between devices and between the network and at least one of a second network, a subnetwork of the network, or a combination thereof. It is to be appreciated that any suitable number of networks can be used with the subject innovation and data communication on networks can be selected by one of sound engineering judgment and/or one skilled in the art.

In certain embodiments, the cloud computing environment 112 can also include a database 116. The database 116 can receive information from the server 110 regarding sensor information, alerts, notifications, historic sensor information, user information, among other information. The database 116 may be a standalone storage component or it may exist as part of the server 110.

A user device 114 may communicate with the cloud computing environment 112 to send and receive information to and from the server 110 and/or the database 116. The user device 114 may be, for example, a computer, or a mobile device such as a smartphone or tablet, a wearable device, among others. The user device 114 may interact with an application 118 operating on the server 110. When executed, the application 118 can interact with the user device 114 to allow a user to view sensor information, view corresponding notifications or alerts, manipulate sensor information, or update settings for the server 110, application 118, controller 102, presence sensor 200, dock door sensor 300, or dock leveler sensor 400. The user device 114 can provide a user interface that allows for user interactions with the application 118. It should be appreciated that in certain embodiments, the application 118 may also exist locally on the user device 114 and receive information from the server 100.

One of ordinary skill in the art can appreciate that the various embodiments of the application 116 described herein can be implemented in connection with any computing device, client device, or server device, which can be deployed as part of a computer network or in a distributed computing environment such as the cloud. The various embodiments described herein can be implemented in substantially any computer system or computing environment having any number of memory or storage units, any number of processing units, and any number of applications and processes occurring across any number of storage units and processing units. This includes, but is not limited to, cloud environments with physical computing devices (e.g., servers) aggregating computing resources (i.e., memory, persistent storage, processor cycles, network bandwidth, etc.) which are distributed among a plurality of computable objects. The physical computing devices can intercommunicate via a variety of physical communication links such as wired communication media (e.g., fiber optics, twisted pair wires, coaxial cables, etc.) and/or wireless communication media (e.g., microwave, satellite, cellular, radio or spread spectrum, free-space optical, etc.). The physical computing devices can be aggregated and exposed according to various levels of abstraction for use by application or service providers, to provide computing services or functionality to client computing devices. The client computing devices can access the computing services or functionality via application program interfaces (APIs), web browsers, or other standalone or networked applications. Accordingly, aspects of the application 118 can be implemented based on such a cloud environment. For example, the application 118 can reside in the cloud computing environment 112 such that the computer-executable instructions implementing the functionality thereof are executed with the aggregated computing resources provided by the plurality of physical computing devices. The cloud computing environment 112 provides one or more methods of access to the subject innovation, which are utilized by the application 118. In an embodiment, software and/or a component can be installed on the user device 114 to allow data communication between the user device 114 and the cloud computing environment 112. These methods of access include IP addresses, domain names, URLs, etc. Since the aggregated computing resources can be provided by physical computing device remotely located from one another, the cloud computing environment 112 can include additional devices such as a routers, load balancers, switches, etc., that appropriately coordinate network data.

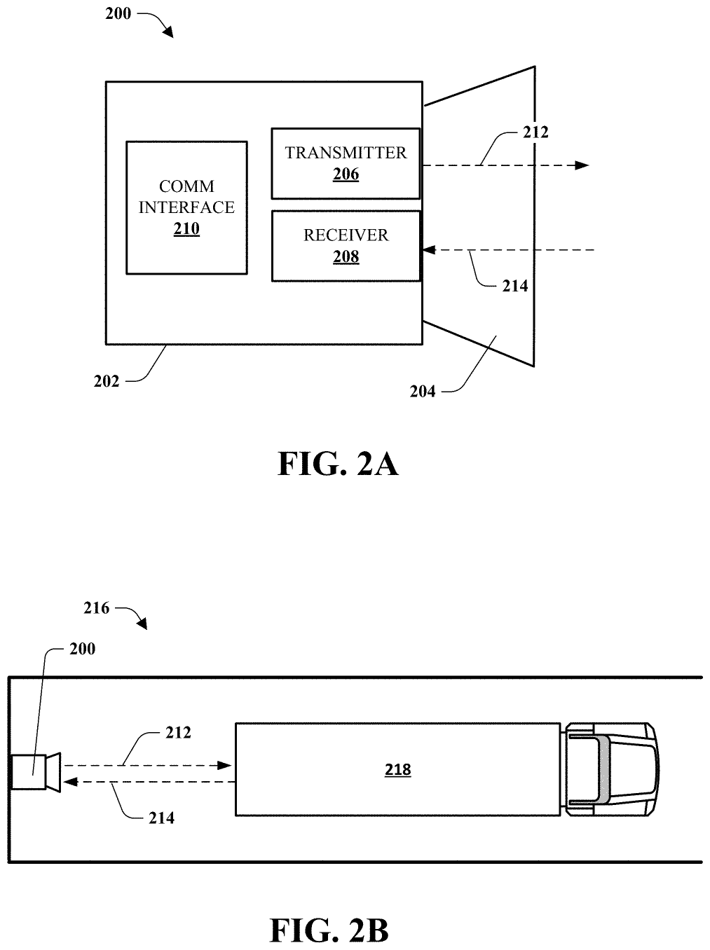

Turning now to FIG. 2A, the presence sensor 200 can include a housing 202 and an aperture 204. Within the casing, the presence sensor 200 includes a transmitter 206 and a receiver 208. The transmitter 206 is configured to transmit a sensing signal 212 such as an ultrasonic wave, a RADAR-based signal, a LIDAR-based signal, among others, through the aperture 204. The receiver 208 is configured to receive a return signal 214 through the aperture, where the return signal 214 is caused by a reflection of the sensing signal 212 off of an object located within range of the sensing signal 212. While FIG. 2A depicts transmitter 206 and receiver 208 as separate components, it is to be appreciated that the transmitting and receiving functionality may be implemented as a single transceiver, such as an ultrasonic transducer, for example.

The housing 202 can further include a communication interface 210 to transmit the presence signal 104 to the controller 102. In certain embodiments, the communication interface 210 can also receive signals from the controller 102 such as control signals for controlling operation (e.g. on/off) of the presence sensor 200 or configuring settings of the presence sensor 200. Settings of the presence sensor 200 can include, for example, sensing signal power, sensing signal frequency, object presence threshold, calibration parameters, among others. It should be appreciated that the communication interface 210 can communicate with the controller 102 over a wired or a wireless communication protocol.

In an embodiment depicted in FIG. 2B, a presence sensor 200 is positioned within a loading dock 216. The presence sensor 200 is positioned such that the sensing signal 212 is transmitted by the transmitter 206 into a predefined area within the loading dock 216 to detect the presence of a truck 218 within the predefined area. For example, the predefined area can be a particular loading area or a lane within the dock or proximate to a door of the dock. If a truck 218 is present and within range of the sensing signal 212, the sensing signal 212 reflects off the truck 218 to create a return signal 214. The sensing signal 212 can be, for example, an ultrasonic wave, a radio wave, light, sound, among others. In certain embodiments, the transmitter 206 may be configured to modulate the signal in either the frequency or amplitude domain. The return signal 214 reflects back towards the presence sensor 200 and is received by the receiver 208. When the return signal 214 is received by the presence sensor 200, the presence sensor can determine a distance of an object (e.g. the truck 218) from the presence sensor 200. The distance can be determined based on, for example, a time delay between transmission of the sensing signal 212 and receipt of the return signal 214, or a difference in frequency between the sensing signal 212 and the return signal 214.

In certain embodiments, the presence sensor 200 is configured to determine when an object is present in a predefined area. For example, the presence sensor 200 may determine that an object is present in the predefined area when the presence sensor 200 receives a return signal 214. In another example, the presence sensor 200 may determine that an object is present in the predefined area when the presence sensor 200 calculates that an object is closer to the presence sensor 200 than a predefined distance threshold. For example, if the distance threshold is 20 meters and the presence sensor 200 determines, based on the received return signal 214, that an object is closer than 20 meters, then the presence sensor 200 determines that an object is present in the predefined area. In further embodiments, the presence sensor 200 is configured to detect a change in the distance of the object from the presence sensor 200. For example, if an object such as a truck 218 is detected to be 5 meters from the presence sensor 200 and the detected distance increases to 25 meters, then the presence sensor 200 can determine that the truck 218 is departing. Similarly, if an object such as a truck 218 is detected by the presence sensor 200 to be 25 meters away from the presence sensor 200 and the detected distance decreases to 5 meters, then the presence sensor 200 can determine that the truck 218 is arriving.

The presence sensor 200 can transmit a presence signal 104 to the controller 102. The presence signal 104 contains information regarding the presence and/or distance of an object. In certain embodiments, the controller can create processed presence information using the information received by the presence signal 104. For example, the controller 102 can record timestamps for various occurrences detected by the presence sensor 200. In one example, the controller can determine and record an arrival time or departure time of an object (e.g. the truck 218) by correlating a time with a detected arrival or departure as communicated to the controller 102 in the presence signal 104. In certain embodiments, the controller 102 may interface with a local annunciator panel, light, or audio alarm such as a siren to provide a local notification for certain situations such as a truck 218 arriving, a truck 218 departing, or a truck 218 distance too close to the presence sensor 200.

The controller 102 can communicate the processed presence information (e.g. object arrival/departure times) to the server 110. The server 110 may store the processed presence information in the server 110 and/or in the database 116, from which a user may access the processed presence information via the user device 114. The server 110 may also have access to a schedule of departure times and arrival times. In certain embodiments, a user may upload the schedule to the server 110 using the user device 114. The server 110 may compare detected arrival times with scheduled arrival times and detected departure times with scheduled departure times. Based on these comparisons, the server may generate various notifications or alerts to notify a user via the application 118 and user device 114. In one example, the server 110 receives a departure time of a truck 218 from the controller 102. The server 110 then compares the departure time to a scheduled departure time and determines that the departure time is later than the scheduled departure time. A rule configured within the application 118 then causes an alert to notify a user via the user device 114 that the truck 218 has departed late. In another embodiment, the server may also use the processed presence information to determine certain parameters. In one example, the server 110 may calculate length of time that a truck is present by determining the amount of time between a truck's 218 arrival and departure. In another example, the server 110 may determine the number of deliveries over a particular period of time by equating one arrival/departure cycle as one delivery and counting the number of deliveries that occur over a time period.

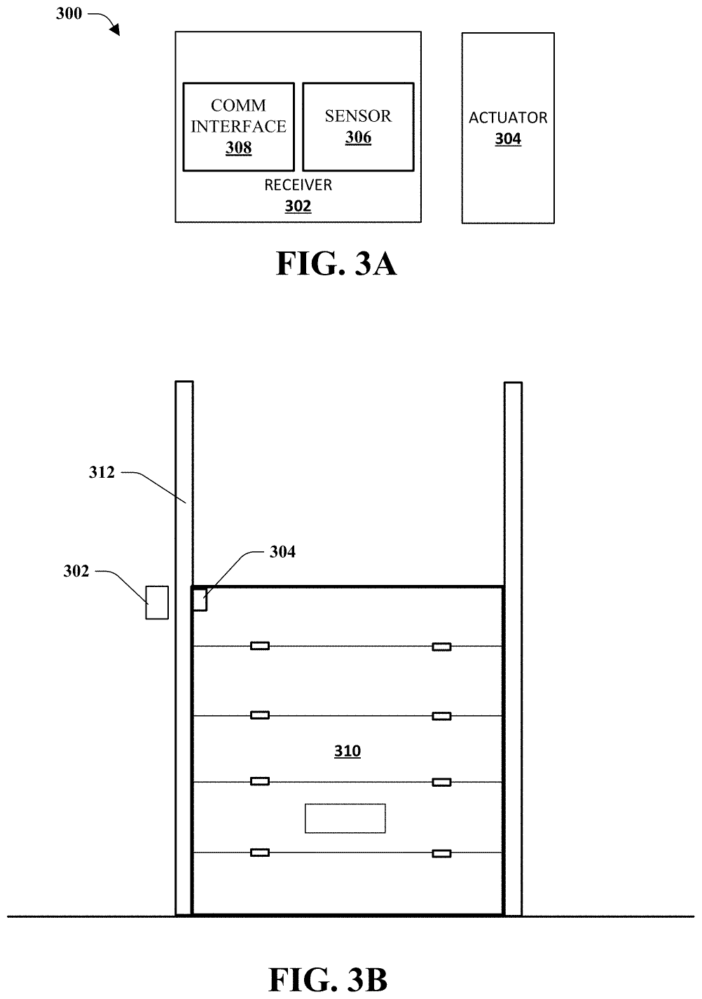

Turning to FIG. 3A, the sensor system 100 can further include a door sensor 300. In one embodiment, the door sensor 300 can include a receiver unit 302 and an actuator 304. The receiver unit 302 is configured to detect a proximity of the actuator 304. In one example, the actuator 304 includes a magnet and the receiver unit 302 can include a sensor 306 to detect by way of magnetism that the actuator 304 is proximate to the sensor 306. The receiver unit 302 can further include a communication interface 308 for transmitting a door signal 106 to the controller 102.

In an embodiment depicted in FIG. 3B, the door sensor 300 can be installed on a door 310 to monitor the opened/closed status of the door 310. The actuator 304 can be fixed to the door 310 and the receiver unit 302 can be fixed to a location proximate to the door such as a location on a wall next to the door 310 or on a track 312 of the door 310. When the door 310 is in a closed position, the actuator 304 is aligned proximate to the receiver unit 302. The receiver unit 302 can detect the presence of the actuator 304 (e.g. by detecting magnetic force) and, as a result, can determine the door 310 to be in a closed position. When the door 310 is opened, the door 310 moves upward along a pair of tracks 312. As the door 310 moves upward, the actuator 304 moves along with the door. When the actuator 304 is no longer aligned proximate to the receiver unit 302, the receiver unit 302 detects the absence of the actuator 304 (e.g. by the absence of magnetic force) and, as a result, can determine the door 310 to be either opening or in an opened position. In another embodiment, the actuator 304 can be fixed to the bottom of the door 310 such that the actuator 304 is aligned proximate to the receiver unit 302 when the door is opened and is absent from the receiver unit 302 when the door is closed.

The door sensor 300 can transmit a door signal 106 to the controller 102, the door signal 106 containing information regarding the opened or closed status of a door 310. In certain embodiments, the controller 102 can create processed door information using the information received by the door signal 106. For example, the controller 102 can record timestamps for various occurrences detected by the door sensor 300. In one example, the controller 102 can determine and record a door opening time or a door close time by correlating a time with a detected transition from a closed state to an opened state or a detected transition from an opened state to a closed state.

The controller 102 can communicate the processed door information (e.g. door opening and closing times) to the server 110. The server 110 may store the processed door information in the server 110 and/or in the database 116, from which a user may access the processed door information via the user device 114. The server 110 may also have access to a maintenance schedule that includes, for example, a predetermined amount of open/close cycles at which certain maintenance should be performed on the door 310. In certain embodiments, a user may upload the maintenance schedule to the server 110 using the user device 114. The server 110 may accumulate or count the number of open cycles and/or closing cycles based on the processed door information. The server 110 may then compare accumulated open or closing cycles to the predetermined amount of open or closing cycles at which maintenance should be performed. If the server 110 determines that the accumulated open or closing cycles equals or exceeds the predetermined amount of open or closing cycles, a rule configured within the application 118 then causes an alert to notify a user via the user device 114 that maintenance is required on the door 310. In another embodiment, the server 110 may also use the processed door information to determine certain parameters. In one example, the server 110 may calculate length of time that the door 310 is open by determining how long the door sensor 300 is indicating an opened state. The server 110 may also calculate length of time that the door 310 is closed by determining how long the door sensor 300 is indicating a closed state.

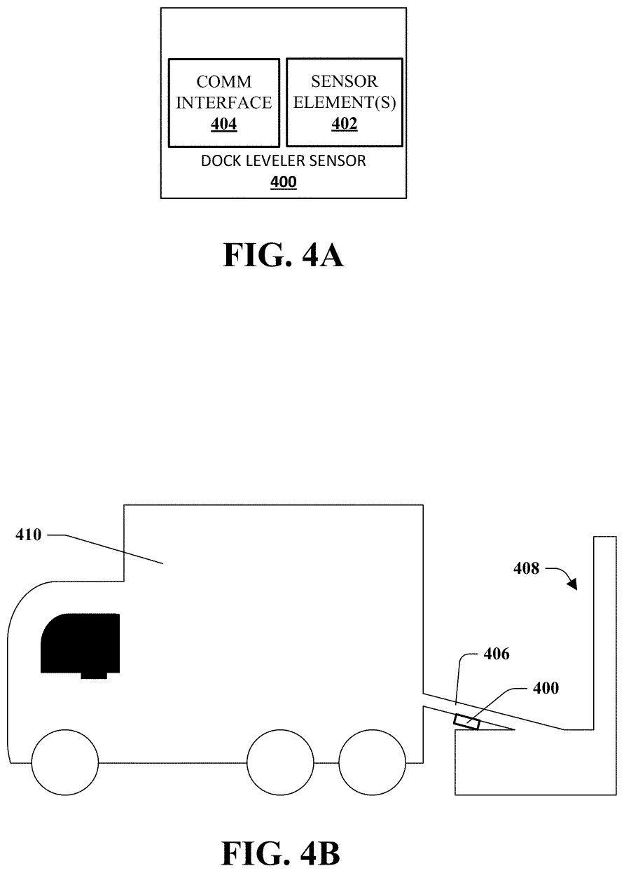

Turning now to FIG. 4A, the sensor system 100 can further include a dock leveler sensor 400. The dock leveler sensor 400 can include a plurality of sensing elements 402. The sensing elements 402 can include a weight scale for detecting a weight applied to a dock leveler, and a position sensor for determining a position of the dock leveler. The dock leveler sensor 400 can further include a communication interface 404 for transmitting a dock leveler signal 108 to the controller 102.

In an embodiment depicted in FIG. 4B, the dock leveler sensor 400 can be installed on a dock leveler 406 located in a loading dock 408. The dock leveler 406 can be operated by raising or lowering the dock leveler 406 at an angle so that the dock leveler 406 can function as an adjustable ramp in unloading cargo from a truck 410 into a loading dock 408 or loading cargo from a loading dock 408 onto a truck 410. The dock leveler 406 can be installed in a variety of configurations including hydraulically activated, mechanically activated (using springs), or pneumatically activated, among others. In certain embodiments, the dock leveler sensor 400 can detect position of the dock leveler 406. The position of the dock leveler 406 can be determined, for example, based on a vertical position of a piston used to raise and lower the dock leveler 406. In certain embodiments, the dock leveler sensor 400 can determine a height of the dock leveler 406, an angle of the dock leveler 406, or discrete position determinations such as whether the dock leveler 406 is raised or lowered. For example, the dock leveler sensor 400 may detect upper and lower travel limits of the dock leveler 406, the dock leveler sensor 400 may sense a plurality of position indicators, or the dock leveler sensor 400 may sense a continuous position value of the dock leveler 406. In certain embodiments, the dock leveler sensor 400 can also include a scale to detect a weight being applied to the dock leveler 406 by, for example, a load being transported across the dock leveler 406.

The dock leveler sensor 400 can transmit a dock leveler signal 108 to the controller 102. The dock leveler signal 108 can contain information regarding the position of the dock leveler 406 or the weight applied to the dock leveler 106. In certain embodiments, the controller 102 can create processed dock leveler information using the information received by the dock leveler signal 108. For example, the controller 102 can record timestamps for various occurrences detected by the dock leveler sensor 400. In one example, the controller 102 can determine and record a dock leveler 406 raise time or a dock leveler 406 lower time by correlating a time with a detected transition from a lowered position to a raised position and vice versa. In another example, the controller 102 can determine and record a timestamp associated with a weight measurement of a load being transported across the dock leveler 406 into or from a truck 410. In certain embodiments, the controller 102 can determine, based on the received position from the dock leveler signal 108 compared to one or more position thresholds, whether the dock is raised or lowered. For example, if the dock leveler 406 is raised above a predetermined height or at an angle greater than a predetermined angle, the dock leveler 406 can be determined to be raised. If the dock leveler 406 is lowered below a predetermined height or at an angle less than a predetermined angle, the dock leveler 406 can be determined to be lowered. Still further, the controller 102 may also determine load count data by counting or accumulate the number of loads transported over the dock leveler 406. In one example, the controller 102 may determine that a complete dock leveler 406 lower/raise cycle, as detected by the dock leveler sensor 400, is one load. In another example, the controller 102 may determine that an applied weight, as detected by the dock leveler sensor 400, in excess of a predetermined weight threshold over a predetermined period of time, is one load.

The controller 102 can communicate the processed dock leveler information (e.g. dock leveler raise/lower times and weights with or without associated timestamps) to the server 110. The server 110 may store the processed dock leveler information in the server 110 and/or in the database 116, from which a user may access the processed dock leveler information via the user device 114. The server 110 may also have access to a maintenance schedule that includes a predetermined amount of raise/lower cycles at which certain maintenance should be performed on the dock leveler 406. The maintenance schedule may also include an accumulated weight limit and/or a total load threshold at which certain maintenance should be performed on the dock leveler 406. In certain embodiments, a user may upload the maintenance schedule to the server 110 using the user device 114.

The server 110 may accumulate or count the number of raise cycles and/or lowering cycles based on the processed dock leveler information. The server 110 may then compare accumulated raise or lowering cycles to the predetermined amount of raise or lowering cycles at which maintenance should be performed. If the server 110 determines that the accumulated raise or lowering cycles equals or exceeds the predetermined amount of raise or lowering cycles, a rule configured within the application 118 then causes an alert to notify a user via the user device 114 that maintenance is required on the dock leveler 406. In another embodiment, the server 110 may also use the processed dock leveler information to determine certain parameters. In one example, the server 110 may calculate a duration that the dock leveler 406 is in a lowered position by determining how long the dock leveler sensor 400 is indicating a lowered state. The duration that the dock leveler 406 is lowered can be used to track the amount of time that a particular truck 410 takes to be loaded or unloaded. The server 110 may also calculate length of time that the dock leveler 406 is in a raised position by determining how long the dock leveler sensor 400 is indicating a raised state. From this information on the server 110, the server 110 may also be able to calculate various statistics such as average load time or number of loads per a particular time period.

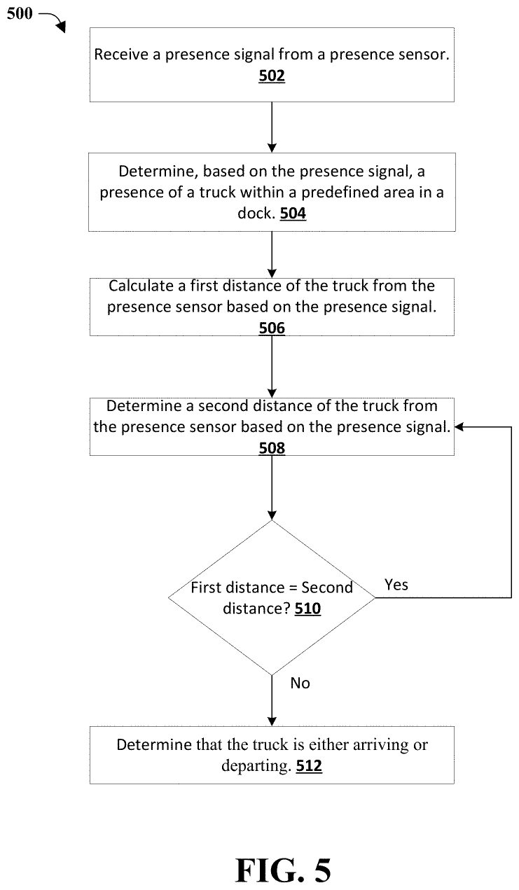

Turning now to FIG. 5, a method 500 for monitoring activity within a dock 216 is depicted. At numeral 502, a presence signal 104 is received from a presence sensor 200. At numeral 504, a presence of a truck 218 within a predefined area in the dock 216 is determined, based on the presence signal 104. At numeral 506, a first distance of the truck 218 from the presence sensor 200 is calculated based on the presence signal 104. At numeral 508, a second distance of the truck 218 from the presence sensor 200 is calculated based on the presence signal 104. At numeral 510, the first distance and the second distance are compared. If the first distance equals the second distance, the method returns to numeral 508 where the second distance of the truck 218 is calculated. If the second distance is different from the first difference, the truck 218 is determined to be either arriving or departing. For example, if the second distance is closer to the presence sensor 200 as compared to the first distance, the truck 218 is determined to be arriving, while if the second distance is further from the presence sensor 200 than the first distance, the truck 218 is determined to be departing.

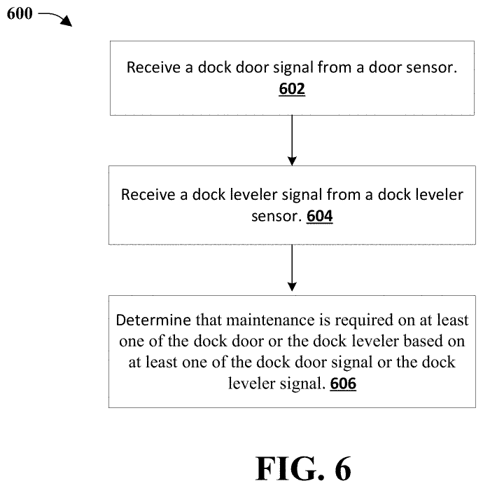

FIG. 6 depicts a method for monitoring activity within a dock 216. It should be appreciated that the methods 600 and 500 may be performed as part of the same method, separately, or simultaneously. At numeral 602, A dock door signal 106 is received from a door sensor 300. At numeral 604, a dock leveler signal 108 is received from a dock leveler sensor 500. At numeral 606, maintenance is determined to be required on at least one of the dock door 310 or the dock leveler 406 based on at least one of the dock door signal 106 or the dock leveler signal 108. The determination that maintenance is required may be made based on a comparison of information received from the dock door signal 106 and the dock leveler signal 108 with a predetermined maintenance schedule. If maintenance is determined to be required, a notification or alert may be displayed to a user via a user device 114.

It is to be appreciated that various features or aspects of the embodiments described herein can be utilized in any combination with any of the other embodiments.

As utilized herein, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Further, as used herein, the term “exemplary” is intended to mean “serving as an illustration or example of something.”

Illustrative embodiments have been described, hereinabove. It will be apparent to those skilled in the art that the above devices and methods may incorporate changes and modifications without departing from the general scope of the claimed subject matter. It is intended to include all such modifications and alterations within the scope of the claimed subject matter. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A sensor system, comprising:
a presence sensor comprising:
a transmitter configured to transmit a sensing signal; and
a receiver configured to receive a return signal reflected off of an object in a predefined area, wherein based on a receipt of the return signal, the presence sensor is configured to transmit a presence signal; and
a controller configured to receive the presence signal from the presence sensor.

2. The sensor system of claim 1, wherein the presence sensor is positioned in a loading dock, wherein the object is a truck and the predefined area is within the loading dock.

3. The sensor system of claim 1, wherein the controller is further configured to calculate a distance of the object from the presence sensor based on the presence signal.

4. The sensor system of claim 3, wherein the controller is further configured to detect a change in the distance of the object from the presence sensor based on the presence signal.

5. The sensor system of claim 1, wherein the controller is configured to determine an arrival time of the object based on the presence signal.

6. The sensor system of claim 5, wherein the controller is configured to determine a departure time of the object based on the presence signal.

7. The sensor system of claim 6, further comprising a server, wherein the server is configured to:
receive, from the controller, the departure time of the object;
determine that the departure time is later than a scheduled departure time; and
based on determining that the departure time is later than the scheduled departure time, provide a notification to a user device.

8. The sensor system of claim 1, wherein the presence sensor further comprises an aperture, wherein the transmitter is configured to transmit the sensing signal through the aperture and the receiver is configured to receive the return signal through the aperture.

9. The sensor system of claim 1, further comprising:
a door sensor comprising:
an actuator; and
a door receiver unit configured to detect a proximity of the actuator and transmit a door position signal based on detection of the proximity of the actuator; and
a dock leveler sensor comprising at least one sensing element configured to detect at least one of a position of a dock leveler, or a weight applied to the dock leveler, wherein the dock leveler sensor is configured to transmit a dock leveler sensor signal including at least one of the position or the weight;
wherein the controller is further configured to receive the door position signal from the door sensor, and the dock leveler signal from the dock leveler sensor.

10. The sensor system of claim 9, wherein the controller is further configured to determine usage data pertaining to a door based on the door position signal.

11. The sensor system of claim 10, further comprising a server configured to:
receive the usage data from the controller;
compare the usage data to a maintenance schedule; and
based on the comparison of the usage data to the maintenance schedule, provide a notification to a user device that maintenance is required on the door.

12. The sensor system of claim 9, wherein the controller is further configured to calculate an amount of time that a door corresponding to the door sensor has been opened.

13. The sensor system of claim 9, wherein the controller is further configured to determine at least one of weight data or operation data pertaining to a dock leveler based on the dock leveler signal.

14. The sensor system of claim 9, wherein the controller is further configured to determine load count data pertaining to a dock leveler based on the dock leveler signal.

15. The sensor system of claim 14, further comprising a server configured to:
receive the load count data from the controller;
compare the load count data to a maintenance schedule; and
based on the comparison of the load count data to a maintenance schedule, provide a notification to a user device that maintenance is required on the dock leveler.

16. A method of monitoring activity within a dock, comprising:
receiving a presence signal from a presence sensor;
determining, based on the presence signal, a presence of a truck within a predefined area in the dock; and
calculating a first distance of the truck from the presence sensor based on the presence signal.

17. The method of claim 16, further comprising:
calculating a second distance of the truck from the presence sensor based on the presence signal;
determining that the second distance is different from the first distance; and
based on determining that the second distance is different from the first distance, determining that the truck is either arriving or departing.

18. The method of claim 16, further comprising:
receiving a dock door signal from a door sensor; and
receiving a dock leveler signal from a dock leveler sensor.

19. The method of claim 18, further comprising:
determining that maintenance is required on at least one of the dock door or the dock leveler based on at least one of the dock door signal or the dock leveler signal.

20. A sensor system, comprising:
a presence sensor positioned within a dock;
a dock door sensor positioned proximate to a dock door;
a dock leveler sensor positioned proximate to a dock leveler;
a controller configured to communicate with the presence sensor, the dock door sensor, and the dock leveler sensor;
and a server configured to receive, from the controller, and store data based on information provided by the presence sensor, the dock door sensor, and the dock leveler sensor, wherein the server is further configured to provide at least one of maintenance information or operational information related to a presence of trucks in the dock, operation of the dock door, and operation of the dock leveler.
